(19) United States
(12) Patent Application Publication
(10) Pub. No.: US 2021/0340757 A1
(43) Pub. Date: Nov. 4, 2021

(54) CONSTRUCTION MODULE FOR USE IN A MODULAR CONSTRUCTION SYSTEM

(71) Applicant: Cristian Marino, Vitacura, Santiago (CL)

(72) Inventor: Cristian Marino, Vitacura, Santiago (CL)

(21) Appl. No.: 17/286,691

(22) PCT Filed: Oct. 18, 2018
(86) PCT No.: PCT/CL2018/050096

§ 371 Date: Apr. 19, 2021

(51) Int. Cl. E04B 1/48; F16B 5/02; F16B 12/14

(52) U.S. Cl. CPC E04B 1/48; E04B 2/56; F16B 12/14; F16B 5/02

(57) ABSTRACT

A construction module for use in a modular construction system, which improves the aesthetic finish and facilitates the operation and assembly of the elements comprising it, said constructive module being formed by at least two units of material and by at least one cylindrical bar that go through the at least two units of material transversely through perforations, wherein said at least one bar comprises on its surface at least two threaded sections separated by a smooth section, each threaded section being located inside each unit of material. The disclosure also consists in a modular construction system configured by at least two construction modules and in a method of assembling a modular construction system.

### CROSS-REFERENCE TO RELATED APPLICATIONS

This application is the National Stage filing under 35 U.S.C. 371 of International Application No. PCT/CL2018/050096, filed on Oct. 18, 2018, the contents of which are all hereby incorporated by reference herein in their entirety.

### FIELD

The present disclosure belongs to the field of the manufacture of base structures for partition walls, floors, roofs, furniture, among others, under the principle of modular construction by means of the use of materials such as wood, metal, plastic, among others.

### BACKGROUND

The present disclosure consists in an improvement to the system described in the invention patent CL 52599 of the same applicant, which describes a basic modular system to obtain a diversity of products, which comprises at least two previously dimensioned material units that are perforated in at least one point of their extension and subsequently aligned and separated in a matrix. The material units are then traversed by at least one threaded bar through at least one perforation of each unit, forming a separation between the material units and between the bars.

An example of the modular system described in patent CL 52599 is illustrated in FIG. 1 attached hereto, showing a chair-shaped object which is composed of 4 modules connected at different angles to each other. Each module is in turn composed of a plurality of material units spaced apart and spanned by three threaded bars. Furthermore, the modules are connected to each other by means of the bar located at least at one of the ends of each module, so that said bar is common to each module and goes through the perforations of the interleaved material units of two modules.

By means of the modular system of the aforementioned patent, it is possible to build a diversity of curved or straight objects and structures by means of a simple and intuitive assembly, without the use of glues, nuts, spacers, etc. In addition, modular manufacturing requires low labor resources and significantly reduces the space used for storage and transportation.

Notwithstanding the above, a drawback of the system proposed by patent CL 52599 is noted having to do first of all with an aesthetic aspect, since the use of threaded bars through the perforations of the material units generates that said thread is seen through the spaces generated between each material unit. This is not appropriate when the structures to be formed by the modules are ornamental objects such as furniture or housing construction structures exposed, since the exposure of such threads are not desirable aesthetically and for other inconveniences such as the accumulation of corrosion in them over time, among others.

Another drawback of using threaded bars in the system proposed by the aforementioned patent is that it makes it difficult to align the material units when such bars must be removed for example for replacement of damaged material units or for repositioning of modules. To avoid the above, the use during the reassembly operation of a toothed die is required in order to ensure uniform spacing between material units, which hinders and slows down the repair or module repositioning operation.

It is therefore the objective of the present invention to overcome the drawbacks observed in the system of patent CL 52599, by means of improvements that ensure a superior aesthetic finish of the modules and that facilitate the alignment and assembly operation of the material units comprising it.

### SUMMARY

According to a first aspect of the present invention, a constructive module is proposed for use in a modular construction system, wherein said constructive module is formed from a set of spaced material units, and by a set of bars going through traversing said set of material units transversely.

Advantageously, the bars that go through the material units have threaded sections separated by smooth sections, so that when the bar is introduced through the perforations of the material units, only the threaded sections remain fixed to the material units, being located and hidden inside the latter. In turn, only the plain sections are visible between each material unit, thus creating a better aesthetic finish than known state-of-the-art systems in which the threaded sections of the bar are visible through the gaps between material units.

The fact of having bars that comprise threaded sections separated by smooth sections also acts as a grading system or reference for the design and alignment of the material units, since the threaded sections are designed and made according to the use that will be given to the construction module, so that their width and the spacing between them exactly define the position in which the bar must be inserted through the perforations of the material units. This advantageously allows achieving uniform spacings and also any custom design to be achieved only by defining the position of the threaded sections on the bar. This is also intuitive for the operators since, for example, for repair operations, aligning each threaded section with its respective material unit is sufficient to achieve the desired configuration of the construction module.

According to a second aspect of the present invention, a modular constructive system is proposed formed from constructive modules as described above, which makes it possible to form a diversity of products of different shapes.

According to a third aspect of the present invention, a method of assembling the modular constructive system of the present invention is proposed, by means of which the manufacture of a large number of structures and products is possible.

Additional advantages of the present invention may be observed from the figures described below, which are intended only to illustrate the features of the invention graphically and not necessarily to limit it to a particular design, shape or specific distribution of its parts and components.

### BRIEF DESCRIPTION OF THE DRAWINGS

FIG. 1 illustrates an object comprising a modular system of the state of the art.

FIG. 2 shows the constructive module of the present invention.

FIG. 3 shows an element of the construction system of the present invention.

FIG. 4 shows a cutaway view of a section of the constructive module of the present invention.

FIGS. 5a to 5d illustrate a particular embodiment of the constructive module of the present invention.

FIG. 6 illustrates an example of the modular constructive system of the present invention.

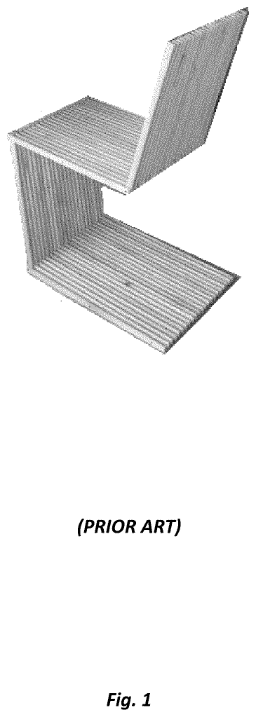

### DETAILED DESCRIPTION

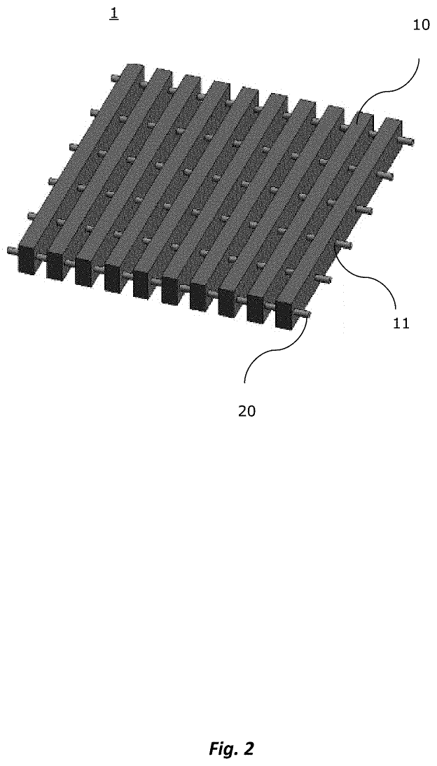

According to the first aspect of the present disclosure, a constructive module 1 is proposed for use in a modular construction system, wherein said constructive module 1 according to FIG. 2 is formed from a set of spaced material units 10 and by a set of cylindrical bars 20 transversally crossing said set of material units 10.

The material units 10 are previously dimensioned with the desired length, width and thickness and perforated with at least two perforations 11 of a diameter preferably smaller than the bars 20. In the embodiment illustrated in FIG. 2, ten material units 10 equidistantly spaced therebetween and six bars 20 equidistantly spaced therebetween are observed. However, the present disclosure is not limited to a particular number of material units and bars, so that only at least two material units 10 and at least one bar 20 are sufficient to form the proposed constructive module 1. Moreover, in alternative embodiments of the disclosure, the spacing of the material units 10 may not necessarily be constant, but also variable as well as the spacing between the bars 20.

According to the present disclosure, each bar 20 is introduced through each material unit 10 through the perforations 11 preferably by means of a suitable tool such as a drill, each of the perforations traversed by a same bar being aligned parallel but not necessarily at the same distance with respect to the ends of each material unit.

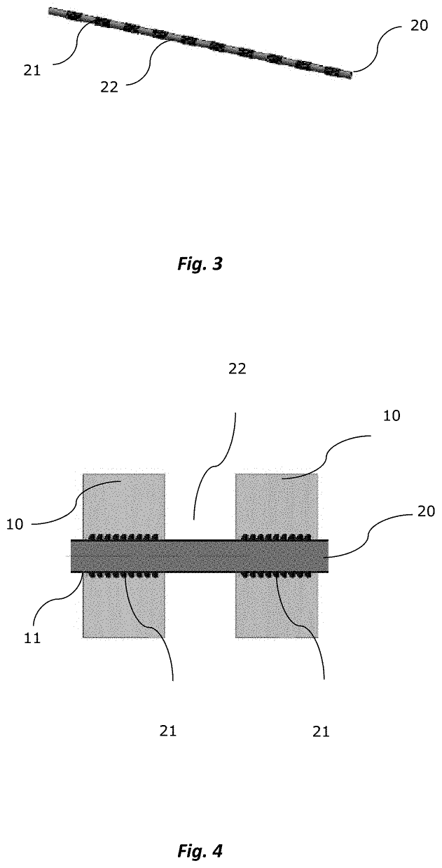

According to FIG. 3, each bar 20 is formed on its surface by at least two threaded sections 21 separated by a smooth section 22, each threaded section 21 being configured with a width less than the width of the material unit 10, so that when the bar 20 is introduced through the perforations of the material units 10, the threaded sections 21 are located inside said material units 10 and only the smooth sections 22 are visible between each material unit 10, as shown in FIG. 4.

According to an alternative embodiment, the material units 10 have an additional free perforation (not illustrated) at least one of their ends, through which a bar is not passed, in order to allow joining with other modules by means of a bar as described above. Such a junction also makes it possible to join displaced modules to each other to form, for example, movable structures.

According to preferred embodiments of the present disclosure, the bars 20 are metallic while the material units 10 may be of materials such as wood, metal, plastic, combinations thereof or any other material. In addition, the material units may be straight, curved, and may have a cross-section of any desired shape.

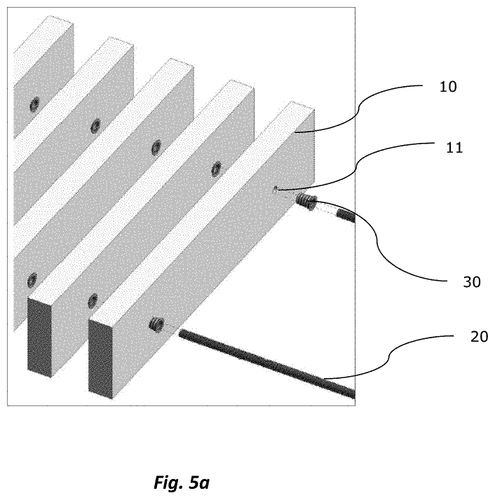

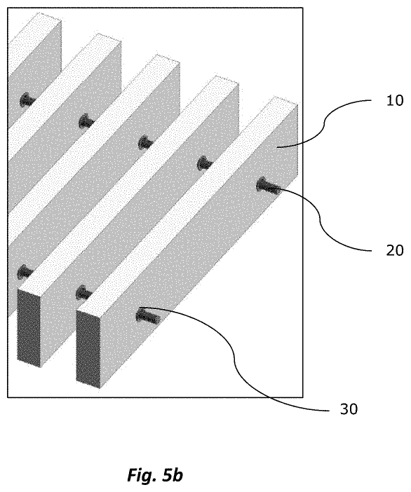

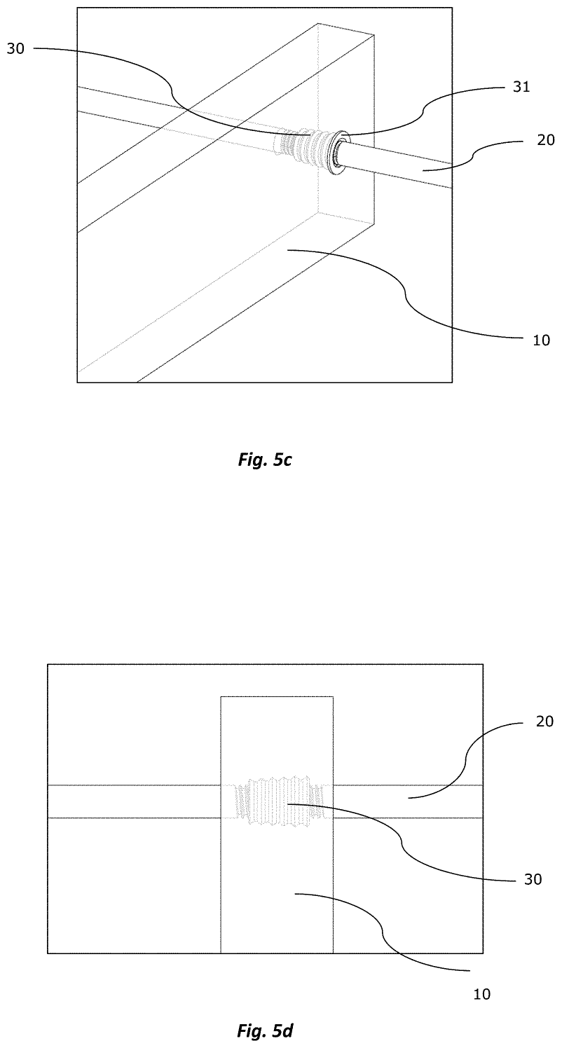

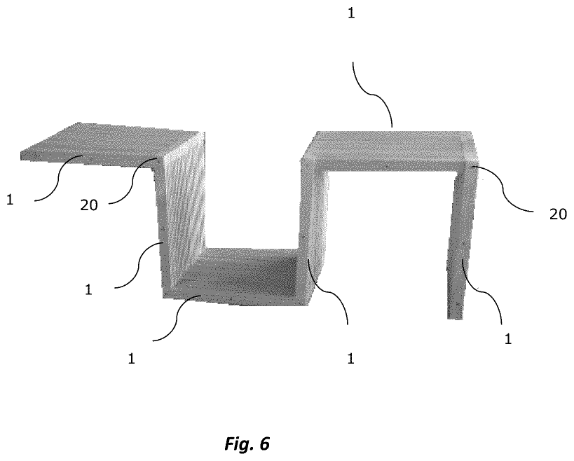

FIG. 5 illustrates another embodiment of the disclosure wherein the perforations 11 of the material units 10 carry a hollow cylindrical insert 30 allowing the passage of the bars 20 as seen in FIG. 5b. Preferably and as seen in FIG. 5a, the insert 30 has its outer surface threaded, so as to be firmly inserted into the material units 10. Preferably, the insert 30 is of a metallic material.

In addition and as can be seen in FIGS. 5c and 5d, the insert 30 also has its inner surface threaded to engage with the threaded section 21 of the bars. This prevents displacement of the latter with respect to the material units 10.

According to the embodiment illustrated in FIGS. 5a to 5c, the insert 30 has a flange 31 at one end which rests on the surface of the material unit 10.

Alternatively and as illustrated in FIG. 5d, the insert 30 has a constant outer diameter so that it is fully inserted into the interior of the material unit 10.

According to the second aspect of the present disclosure, by means of the constructive module 1 proposed, it is possible to obtain a modular constructive system for the manufacture of all types of structures.

An example of a structure manufactured from the proposed constructive modules is illustrated in FIG. 5, showing an arrangement of six constructive modules 1 connected at right angles. For this purpose, the system comprises at least two modules connected by interlocking their respective material units 10. In the illustrated example, the material units of two adjacent modules are interlocked at the ends and positioned at 90° angles. However and according to alternative embodiments of the disclosure, the adjacent material units 10 of each module may be interlocked at the center or at any position of the modules and angled in different positions, for example to form connections between modules in the shape of “X”, “+”, “L”, or any other desired shape.

Adjacent material units 10 of each module are connected by means of at least one bar 20 in common to both modules, being in the illustrated example, by means of the bar located at one or both ends of each module. However, the common bar 20 between each module could be one located at the center or any other located at some intermediate position of the module.

By means of the modular construction system proposed, it is therefore possible to build diverse structures with a great flexibility of design, which will be determined by the way of connection between the modules and the intrinsic characteristics of the components of each one of them, being able to form curved, straight, mixed structures and with different types of materials.

According to the third aspect of the present disclosure, the method of assembly of the modular construction system comprises:

(a) having at least two units of the constructive module 1 with at least one free perforation at some point of its extension;

b) having a bar 20 formed on its surface by at least two threaded sections 21 separated by a smooth section 22;

c) interlocking the material units 10 of two adjacent modules, aligning their free perforations;

d) rotating one of the modules in relation to an adjacent one, until the desired angle of separation between the two units is obtained; and

e) inserting the bar through the free perforations of the adjacent modules, in order to fix and join them, thus avoiding the displacement of one module with respect to the other. This step comprises locating the threaded sections 21 of bar 20 inside the material units 10 and locating the smooth sections 22 of the bar 20 between the material units 10.

According to an alternative embodiment of the proposed method, step a) comprises arranging inserts 30 in the perforations so that in step e), the bars are inserted by said inserts through the perforations.

The system and constructive method proposed by the present disclosure can be used in the manufacture of base structures of partition walls, floors and roofs, which can be coated with some plate or sheet for their finishing. In addition, the constructive modules can be placed both horizontally and vertically.

For example, the constructive modules proposed here can be used as interior finishing products, such as the installation of American type false ceilings, façade cladding, blinds, and lattices.

In the area of furniture, the modular construction system proposed can be used for the construction of all types of furniture or use the modules as cladding for the same.

1. A construction module for use in a modular construction system to improve the aesthetic finish and facilitate the operation and assembly of the elements comprising it, said constructive module being formed by at least two material units and by at least one cylindrical bar transversely going through the at least two material units through perforations, wherein said at least one bar comprises on its surface at least two threaded sections separated by a smooth section, each threaded section being located inside each material unit.

2. The construction module according to claim 1, wherein the threaded sections have a smaller width than the material units.

3. The construction module according to claim 1, wherein the perforations have a smaller diameter than the bars.

4. The construction module according to claim 1, wherein the perforations contain a hollow cylindrical insert.

5. The construction module according to claim 4, wherein the insert has a threaded inner and outer surface.

6. The construction module according to claim 4, wherein the insert has a flange at one end.

7. The construction module according to claim 1, wherein the spacing between material units is constant.

8. The construction module according to claim 1, wherein the spacing between material units is variable.

9. The construction module according to claim 1, wherein the spacing between bars is constant.

10. The construction module according to claim 1, wherein the spacing between bars is variable.

11. The construction module according to claim 1, wherein the material units have an additional free perforation in at least one of their ends.

12. The construction module according to claim 1, wherein the at least one bar is metallic.

13. The construction module according to claim 1, wherein the material units are made of materials comprised within the group of: wood, metal, plastic or combinations thereof.

14. The construction module according to claim 1, wherein the construction module comprises straight, curved material units of combinations thereof.

15. A modular construction system to improve the aesthetic finish and facilitate the operation and assembly of the elements comprising it, being configured by at least two constructive modules according to claim 2, which are connected by means of the interlacing of material units joined by means of at least one common cylindrical bar going through them transversely through perforations aligned and located in the respective interlaced material units, wherein said at least one bar comprises on its surface at least two threaded sections separated by a smooth section, each threaded section being located inside each unit of material.

16. The construction system according to claim 15, wherein the material units of one construction module are interlocked with the ends of the material units of the adjacent module.

17. The construction system according to claim 15, wherein the material units of one construction module are interlocked with an intermediate section of the material units of the adjacent module.

18. The construction system according to claim 15, wherein the material units of one module form an angle with respect to the material units of the adjacent module.

19. A method of assembly of a modular construction system according to claim 15 to improve the aesthetic finish and facilitate the operation and assembly of the elements comprising it, comprising:
(a) having at least two units of the construction module with at least one free perforation at some point of its extension;
b) having a bar;
c) interlocking the material units of two adjacent modules, aligning their free perforations;
d) rotating one of the modules in relation to another adjacent one, until obtaining the desired angle of separation between the two units; and
e) inserting the bar through the free perforations of the adjacent modules, in order to fix and join them, thus avoiding the displacement of one module with respect to another;
wherein the step e) comprises locating threaded sections of the bar inside the material units and locating smooth sections of the bar between the material units.

20. The method according to claim 19, wherein the step a) comprises arranging inserts in the perforations and step e) comprises inserting the bars through said inserts through the perforations.
